(19) United States
(12) Patent Application Publication
(10) Pub. No.: US 2022/0314093 A1
(43) Pub. Date: Oct. 6, 2022

(54) SYSTEM WITH MOTION CAPTURE FUNCTION APPLIED TO ICE HOCKEY PASS- AND-CONTROL TRAINING

(71) Applicant: Potent Sports & Tech Co., Ltd, Nantong, Jiangsu (CN)

(72) Inventor: Li WANG, Nantong, Jiangsu (CN)

(21) Appl. No.: 16/972,005

(22) PCT Filed: Sep. 10, 2020
(86) PCT No.: PCT/CN2020/114532

§ 371 Date: Dec. 4, 2020

(51) Int. Cl. A63B 69/00; A63B 71/06

(52) U.S. Cl. CPC A63B 69/0026; A63B 71/0622; A63B 2071/0677; A63B 2071/0647; A63B 2102/24

(57) ABSTRACT

Disclosed is a system with motion capture function applied to ice hockey pass-and-control training, including a running part, a detection part and a display part. The detection part and the display part are in communication connection. The running part is ice hockey device with identifying characteristics, and the running part and the detection part are set to cooperate correspondingly; the detection part is used to detect the running part and capture the movement of the running part to form a detection signal and transmit it to the display part; the display part is used to store the virtual scene, receive the detection signal, and display part of the detection signal in the virtual scene for display. The system with motion capture function applied to ice hockey pass-and-control training of the disclosure has the advantages of low manufacturing cost, free of site restrictions, and realization of hand-eye separation of training methods.

### CROSS REFERENCE TO THE RELATED APPLICATIONS

This application is the national phase entry of International Application No. PCT/CN2020/114532, filed on Sep. 10, 2020, which is based upon and claims priority to Chinese Patent Applications No. 202010864896.3, filed on Aug. 25, 2020, the entire contents of which are incorporated herein by reference.

### FIELD

The present invention relates to a sports training system, in particular to a system with motion capture function applied to ice hockey pass-and-control training.

### BACKGROUND

At present, ice hockey training generally needs to be carried out on professional ice rinks. Traditional training is mainly based on on-site coaching by coaches, which lacks standardized, digital, replicable and self-learning independent training methods. The training costs are high, training efficiency is low, and training methods are limited. It is not conducive to the popularization and promotion of ice hockey and to personal training. Therefore, ice hockey training technology urgently needs to improve efficiency through the research and development of ice hockey training products.

### SUMMARY

The purpose of the present invention is to provide a system with motion capture function applied to ice hockey pass-and-control training to solve one or more of the above-mentioned existing problems.

The present invention proposes a system with motion capture function applied to ice hockey pass-and-control training, including a running part, a detection part and a display part, and the detection part and the display part are in communication connection.

The running part is a device with identifying characteristics, and the running part and the detection part are set to cooperate correspondingly; the detection part is used to detect the running part, and capture the movement of the running part to form a detection signal and transmit it to the display part; the display part is used to store a virtual scene, receive the detection signal, and display part of the detection signal in the virtual scene for display.

In some embodiments, the display part is in communication connection with a server.

In some embodiments, the detection signal contains an image signal of images of the running part, and the display part is used to add a simulation model corresponding to the image of the running part to the virtual scene.

In some embodiments, a judgment rule and a mode name are stored in the display part, and the mode name is set corresponding to the judgment rule, and a judgment is made according to the judgment rule.

In some embodiments, the judgment rule includes fixed-point judgment rules, and the fixed-point judgment rule includes virtual ice hockey setting rules, virtual ice hockey identification, virtual ice hockey identification order, and score.

In some embodiments, a method of the fixed-point judgment includes the following steps:

set the virtual ice hockey in the virtual scene according to the virtual ice hockey setting rules in the fixed-point judgment rules, and add the corresponding virtual ice hockey identification;

do edge detection and obtain binary images of the running part;

find position of the virtual ice hockey and judge whether there is an image of the running part in the virtual ice hockey;

obtain the order in which the running part appears in the virtual ice hockey, and form the current virtual ice hockey identification order according to the virtual ice hockey identification;

compare the current virtual ice hockey identification order with the virtual ice hockey identification order in the judgment rule.

In some embodiments, the judgment rule includes a trajectory judgment rule, and the fixed-point judgment rule includes an area division rule, area identification, region identification order, and score.

In some embodiments, the trajectory judgment rule includes the following steps:

divide the virtual scene into multiple areas according to the area division rule and area identification in the trajectory judgment rule, and add area identifications;

obtain the order in which the images of the running part appear in the corresponding area, and form the current area identification order according to the area identification;

compare the current area identification order with the area identification order in the judgment rule.

The system with motion capture function applied to ice hockey pass-and-control training is applied to ice hockey training to form an ice hockey training system, including ice hockey, ice hockey stick, image acquisition device and display device, and the image acquisition device is in communication connection with the display device.

An identification feature is provided on the ice hockey as an running part; the ice hockey is provided with an identification feature, which acts as a detection part for operating the image acquisition device, and the irradiation area of the image acquisition device corresponds to the virtual scene, and is used to detect the ice hockey, capture the action of the ice hockey, and form an image signal containing the image of the ice hockey; the display device is used as a display part, and the display device is used to store judgment rules and virtual scenes, receive image signals, obtain position information of the ice hockey image in the irradiation area, add the hockey image to the virtual scene according to the position information and display it, and judge according to the position of the ice hockey image in the virtual scene and the judgment rules.

In some embodiments. the identification feature includes one or more elements of color, shape, and pattern.

The advantage of the system with motion capture function applied to ice hockey pass-and-control training of the present invention is that it includes physical components of the running part, the detection part and the display part, uses the virtual scene of the display part, breaks the limitation of the sports field and is also convenient to promote the sport.

### BRIEF DESCRIPTION OF THE DRAWINGS

FIG. 1 is a schematic structural diagram of a system with motion capture function applied to ice hockey pass-and-control training in an embodiment of the present invention.

FIG. 2 is a schematic structural diagram of a setting rule of a scene with a plane view of single point dribble an embodiment of the present invention.

FIG. 3 is a schematic structural diagram of a setting rule of a scene with a plane view of two-point cross dribble in an embodiment of the present invention.

FIG. 4 is a schematic structural diagram of a setting rule of a scene with a plane view of horizontal two-point obstacle dribble in an embodiment of the present invention.

FIG. 5 is a schematic structural diagram of a setting rule of a scene with a plane view of longitudinal two-point obstacle dribble in an embodiment of the present invention.

FIG. 6 is a schematic structural diagram of a setting rule of a scene with a plane view of four-point obstacle dribble in an embodiment of the present invention.

FIG. 7 is a flowchart of a running method of the ice hockey training system in an embodiment of the present invention.

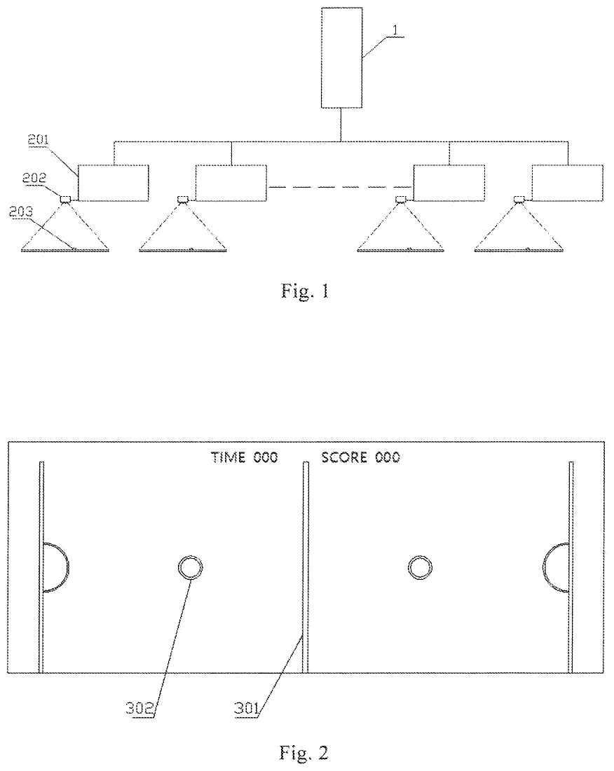

### DETAILED DESCRIPTION

This embodiment proposes an ice hockey training system that applies a system with motion capture function applied to ice hockey pass-control training to ice hockey training. One user corresponds to one ice hockey training system, and each ice hockey training system includes hockey puck, hockey stick, and an image acquisition device and a display device.

The hockey stick is used to drive the hockey puck to move.

The hockey puck is used as the running part 203. The outer surface of the hockey puck is orange color or has a specific pattern, and the orange color or specific pattern is used as the identification feature. The position of the hockey puck corresponds to the position of the image acquisition device, that is, the hockey puck is placed in the irradiation area of the image acquisition device.

The image acquisition device is used as the detection part 202. The image acquisition device can adopt a camera, which is fixedly installed above the flat ground (can be clamped on the edge of a table to realize a fixed installation), and the camera lens is aligned with the flat ground (the flat ground that the lens is aligned with is preferably a ground that possesses large color difference with the color of the ice hockey, little lines, and little noise), and the irradiation area of the image acquisition device corresponds to the virtual scene, which is used to detect the ice hockey, capture the action of the ice hockey, and form an image signal containing the image of the ice hockey.

The display device is used as the display part 201. The display device can be a smart display device such as a smart TV. The application program is installed on the smart display device. The smart display device downloads the mode name, judgment rules and virtual scenes, and stores them in a local database. The device and the camera form a communication connection through a data line or wireless signal, receive image signals, obtain position information of the ice hockey image in the irradiation area, add the ice hockey image to the virtual scene according to the position information and display it, and judge according to the position of the ice hockey image in the virtual scene and the judgment rules. The mode name and judgment result form a local history record which is stored in the local database. When the smart display device is connected with the server 1, the local history record will be uploaded to server 1 with a user name corresponding to the display device.

Meanwhile, through the smart display device, the history records corresponding to other user names through the communication network, or the history records corresponding to the same mode name and the user names corresponding to the history records can be viewed.

The display device in each ice hockey training system is in communication connection with the server 1. The server 1 stores the user name, user login password, total score, and history records. The user login password, total score and history records all correspond to the user name.

The virtual scene includes a scene with a plane angle of view and a scene with a 3D angle of view, and the present embodiment takes the scene with a plane angle of view as an example.

In this embodiment, “SCORE 000” is provided above the virtual scene, where “000” represents the total score of this training.

In this embodiment, “TIME 000” is also provided above the virtual scene, where “000” represents the training time.

The mode names and judgment rules in this embodiment are specifically shown in Table 1 below, in which the center point refers to the center point of the area between the two limit lines 304. The area identification sequence of the horizontal two-point obstacle dribble refers to the formation of a hockey puck that runs around the two first obstacle points 305 to form a ∞-shaped first periodic trajectory; the area identification sequence of the longitudinal two-point obstacle dribble refers to the formation of a hockey puck that runs around the two second obstacle points 310 to forming a second periodic trajectory in the shape of a figure of 8; the area identification sequence of the four-point obstacle dribble refers to the formation of a continuous hockey puck that runs around each third obstacle point 315 to form a third periodic trajectory, which includes a closed trajectory formed around each third obstacle point 315, and there are many kinds of area identification sequences that form the trajectory, which are illustrated in Table 1.

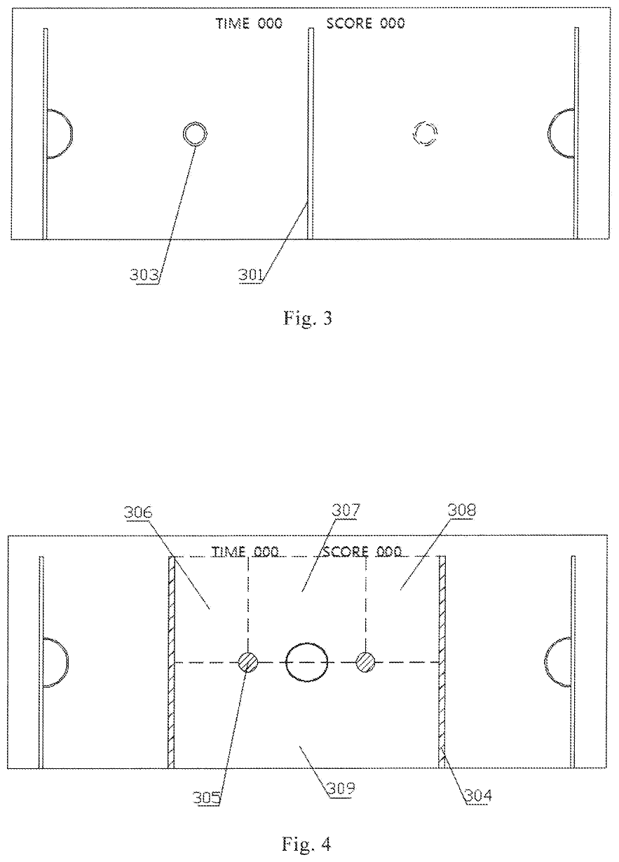

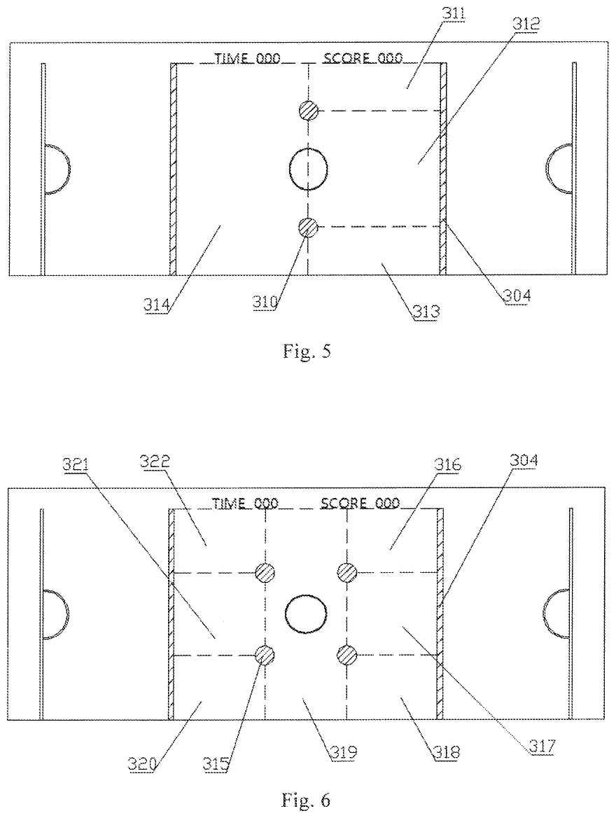

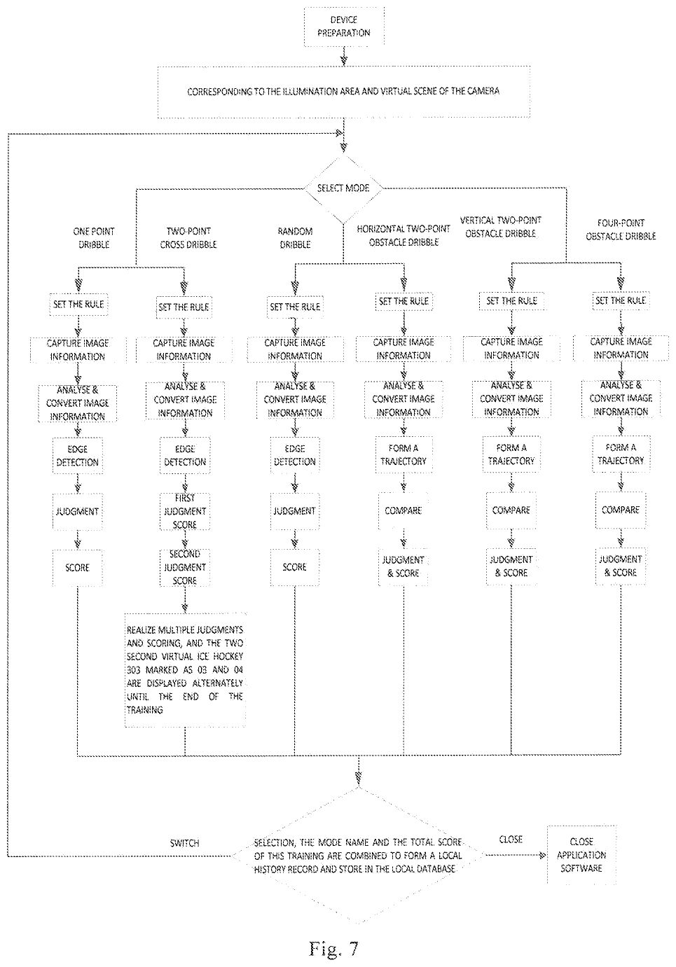

TABLE 1

| | | | | Trajectory judgment rule | | |
|---|---|---|---|---|---|---|
| | Fixed-point judgment rule | | | Horizontal | Longitudinal | Four- |
| | One | Two-point | | two-point | two-point | point |
| Mode | point | cross | Random | obstacle | obstacle | obstacle |
| name | dribble | dribble | dribble | dribble | dribble | dribble |
| Set the | Virtual hockey setting rules | | | Zoning rules | | |
| rule | As shown in | As shown in | Randomly | As shown in | As shown in | As shown in |
| | FIG. 2, a | FIG. 3, a | generate | FIG. 4, two | FIG. 5, two | FIG. 6, four |
| | first virtual | second virtual | virtual hockey | first obstacle | second obstacle | third obstacle |
| | hockey puck | hockey puck | pucks (that is, | points 305 are | points 310 are | points 315 are |
| | 302 is set on | 303 is set on | the display | set symmetrically | set longitudinally | evenly set on |
| | both sides of | both sides of | position of the | about the center | and symmetrically | the two limit |
| | the center line | the center line | virtual hockey | point laterally | about the center | lines 304 with |
| | 301, and two | 301. Two second | puck is random) | between the two | point between | the center point |
| | first virtual | virtual hockey | | limit lines 304, | the two limit | as the center of |
| | hockey pucks | pucks 303 are | | avoiding the two | lines 304, | the circle, |
| | 302 are | displayed | | first obstacle | avoiding the | avoiding the four |
| | displayed at | alternately. | | points 305 to | two second | obstacle points |
| | the same time. | The image of | | divide the area | obstacle points | and dividing the |
| | | the ice hockey | | between the two | 310 to divide | area between the |
| | | puck appears | | limit lines 304 | the area between | two limit lines |
| | | in the displayed | | into four areas, | the two limit | 304 into seven |
| | | second virtual | | namely the first | lines 304 into | areas, namely |
| | | ice hockey 303 | | area 306, the | four areas, namely | the ninth area |
| | | and disappears, | | second area 307, | the fifth area 311, | 316, the tenth |
| | | and another | | the third area | the sixth area 312, | area 317, the |
| | | second virtual | | 308, and the | the seventh area | eleventh area 318, |
| | | ice hockey 303 | | fourth area 309. | 313, and the 8th | the twelfth area |
| | | is displayed. | | | area 314. | 319, the thirteenth |
| | | | | | | area 320, the |
| | | | | | | fourteenth area |
| | | | | | | 321 and the |
| | | | | | | fifteenth area 322. |
| Identification | The two first | The | The | The | The | The |
| order | virtual hockey | identification | identification | identification | identification | identification |
| | pucks 302 are | of the two | of the virtual | of the first | of the fifth | of the ninth |
| | identified as: | second virtual | ice hockey is: | area 306, the | area 311, the | area 316, the |
| | 01 and 02. | ice hockey 303 | 0 (4 + n), | second area 307, | sixth area 312, | tenth area 317, |
| | | are: 03 and 04 | where n identifies | the third area | the seventh area | the eleventh area |
| | | | the number of | 308, and the | 313, and the 8th | 318, the twelfth |
| | | | times the virtual | fourth area 309 | area 314 are: | area 319, the |
| | | | ice hockey appears | are; 1, 2, 3, 4, | 5, 6, 7, 8 | thirteenth area |
| | | | randomly | respectively | respectively | 320, the fourteenth |
| | | | | | | area 321, and the |
| | | | | | | fifteenth area 322 |
| | | | | | | are: 9, 10, 11, 12, |
| | | | | | | 13, 14, 15. |
| Identification | 01; 02 | 03; 04 | 0 | 1-4-2-3-4-2- | 5-8-6-7-8-6- | 9-10-12-15-14- |
| order | | | (4 + n) | 1-4; 1-2-4-3- | 5-8; 5-6-8-7- | 12-10-19-12-10- |
| | | | | 2-4-1-2 | 6-8-5-6 | 11-12-15-14 |
| Score | 1 | 1 | 1 | 1 | 1 | 1 |

As shown in FIG. 7, the running method of the ice hockey training system described in this embodiment includes the following steps:

Step 1: prepare equipment: select a training site with a flat ground surface, fix the camera above the training site, so that the camera lens is set downward, aiming at the flat ground of the training site, place the orange color ice hockey puck on the flat ground in the camera irradiation area, and form a communication connection between the camera and the intelligent display device through the data cable.

Step 2: corresponding to the camera's irradiation area and virtual scene, turn on the camera, run the application software on the smart display device to display the virtual scene on the smart display device, and enable the irradiation area of the camera correspond to the virtual scene by adjusting the height of the camera or the focal length of the camera.

Step 3: select a mode; perform judgments, and scoring; at the same time, the mode and scoring results are combined to form a local history record. The selectable modes include:

3.1: when selecting single point dribble, the specific judgment method includes the following steps:

Step 3.1.1: set the rules: set two first virtual hockey pucks 302 in the virtual scene according to the setting rules of single point dribble, and add the corresponding virtual hockey puck identification 01 and 02, as shown in FIG. 2.

Step 3.1.2: collect image information; the camera collects the image information containing the ice hockey image, and transmits the image information to the smart display device.

Step 3.1.3: analyze and convert the image information; analyze and convert the image information in the smart display device, use the HSV and RGB color range to select orange color pixels, filter out other colors, form a virtual model of the ice hockey, and add the virtual model to the virtual scene, capture the shape of the ice hockey puck through the camera, and display the shape of the ice hockey corresponding to a position in the virtual scene through the actual shape of the ice hockey.

Step 3.1.4: edge detection; use the canny algorithm to do edge detection on the virtual model of the ice hockey to obtain the ice hockey binary image, that is, the contour of the ice hockey.

Step 3.1.5: make a judgment; use the Hough algorithm to find the virtual ice hockey position, and determine whether there is a virtual model of the ice hockey in the first virtual ice hockey 302. The virtual model of the ice hockey in the first virtual ice hockey 302 identified as 01 is recorded as “01” ”, the virtual model of the ice hockey puck in the first virtual hockey puck 302 identified as 02 is recorded as “02”.

Step 3.1.6: score; if any one of “01” and “02” appears once, the total score of the previous training will be increased by 1, and it will be updated to the total score of this training;

3.2: when selecting two-point cross dribble, the specific judgment method includes the following steps:

Step 3.2.1: set the rules; set two second virtual hockey pucks 303 in the virtual scene according to the setting rules of the two-point cross dribble, and add the corresponding virtual hockey puck identification 03 and 04, as shown in FIG. 3. In the two second virtual hockey puck 303, the second virtual hockey puck 303 identified as 03 is displayed, and the second virtual hockey puck 303 identified as 04 is hidden;

Step 3.2.2: collect image information; the camera collects the image information containing the ice hockey image, and transmits it to the smart display device.

Step 3.2.3: analyze and convert the image information; analyze and convert the image information in the smart display device, use HSV and RGB color range to select orange color pixels, filter out other colors, form a virtual model of the ice hockey, and add it to the virtual scene; use the camera to capture the shape of the hockey puck, and display the actual shape of the hockey puck corresponding to the position in the virtual scene.

Step 3.2.4: edge detection; use the canny algorithm to do edge detection on the virtual model of the ice hockey to obtain the ice hockey binary image, that is, the contour of the ice hockey.

Step 3.2.5: first judgment and score; use the Hough algorithm to find the virtual ice hockey position, and determine whether there is a virtual ice hockey model in the second virtual ice hockey 303 identified as 03. If it appears, it will be recorded as “03”; the total score of the last training will be increased by 1 and updated to the total score of this training.

Step 3.2.6: second judgment and score; after the virtual model of the hockey puck appears in the second virtual hockey puck 303 with the identification 03, the second virtual hockey puck 303 identified as 03 is hidden, and the second virtual hockey puck 303 identified as 04 is displayed, and then repeat the above steps 3.2.3 to 3.2.5 to determine whether there is a virtual model of the ice hockey in the second virtual ice hockey 303 identified as 04. If it appears, it will be recorded as “04”. The total score of the previous training is increased by 1 and updated to the total score of this training.

Step 3.2.7: repeat step 3.2.6 to achieve multiple judgments and scoring, and the two second virtual hockey pucks 303 identified as 03 and 04 are displayed alternately until the end of the training.

3.3: when selecting random dribble, the specific judgment method includes the following steps:

Step 3.3.1: select random dribble; practice the specific judgment method steps 3.3.1, set the rules, a virtual ice hockey randomly appears in the virtual scene according to random dribble setting rules; including the following steps.

Step 3.3.2: collect image information; the camera collects the image information containing the ice hockey image, and transmits it to the smart display device.

Step 3.3.3: analyze and convert the image information; analyze and convert the image information in the smart display device, use the HSV and RGB color range to select orange color-red pixels, filter out other colors, form a virtual model of the ice hockey, and add it to the virtual scene, use the camera to capture the shape of the ice hockey puck, and correspond to the position in the virtual scene through the actual ice hockey shape and display it.

Step 3.3.4: edge detection; use the canny algorithm to do edge detection on the virtual model of the ice hockey to obtain the ice hockey binary image, that is, the contour of the ice hockey.

Step 3.3.5: make a judgment; use the Hough algorithm to find the virtual ice hockey position, and determine whether there is a virtual model of the ice hockey in the virtual ice hockey. If it appears, it will be recorded as “00”.

Step 3.3.6: score; if “00” appears once, the total score of the previous training will be increased by 1, and updated to the total score of this training.

3.4: select the horizontal two-point obstacle dribble; the specific judgment method includes the following steps:

Step 3.4.1: set the rules; set four areas in the virtual scene according to the setting rules of the horizontal two-point obstacle dribble, namely the first area 306, the second area 307, the third area 308 and the fourth area 309, and add the corresponding identification 1, 2, 3, 4, as shown in FIG. 4.

Step 3.4.2: collect image information; the camera collects the image information containing the ice hockey image, and transmits it to the smart display device.

Step 3.4.3: analyze and convert the image information; analyze and convert the image information in the smart display device, use HSV and RGB color range to select orange color-red pixels, filter out other colors, form a virtual model of ice hockey, and add it to the virtual scene, and display it. As the hockey puck runs, the virtual model of the hockey puck also runs in the virtual scene.

Step 3.4.4: form a running trajectory; as the virtual model of the ice hockey puck runs, record the identification of the area passed by the virtual model of the ice hockey in order to form a running trajectory.

Step 3.4.5: compare; compare the running trajectory with the sequence of region identification in the judgment rule.

Step 3.4.6: make a judgment and score; when there is a trajectory in the running trajectory that is consistent with the sequence of the region identification in the judgment rule, the total score of the last training is increased by 1, and it is updated to the total score of this training. At the same time, the running trajectory starts to re-record and enter step 3.4.5 until the training is completed.

3.5: select the longitudinal two-point obstacle dribble; the specific judgment method includes the following steps:

3.5.1: set the rules; set four areas in the virtual scene according to the setting rules of the longitudinal two-point obstacle dribble, namely the fifth area 311, the sixth area 312, the seventh area 313 and the eighth area 314, and add the corresponding identification 5, 6, 7, 8, as shown in FIG. 5.

Step 3.5.2: collect image information; the camera collects the image information containing the ice hockey image, and transmits it to the smart display device.

Step 3.5.3: analyze and convert the image information; analyze and convert the image information in the smart display device, use the HSV and RGB color range to select orange color-red pixels, filter out other colors, form a virtual model of the ice hockey puck, and add it to the virtual scene, and display it. As the hockey puck runs, the virtual model of the hockey puck also runs in the virtual scene.

Step 3.5.4: form a movement trajectory; as the virtual model of the ice hockey puck runs, record the identification of the area passed by the virtual model of the ice hockey in order to form a movement trajectory.

Step 3.5.5: compare; compare the running trajectory with the sequence of region identification in the judgment rule.

Step 3.5.6: make a judgment and score; when there is a trajectory in the running trajectory that is consistent with the sequence of region identification in the judgment rule, the total score of the last training will be increased by 1, and it will be updated to the total score of this training. At the same time, the running trajectory starts to re-record and enter step 3.5.5 until the training is completed.

3.6: choose four-point obstacle dribble; the specific judgment method includes the following steps:

Step 3.6.1: set the rules; according to the four-point obstacle dribble setting rules, set seven areas in the virtual scene, namely the ninth area 316, the tenth area 317, the eleventh area 318, the twelfth area 319, the thirteenth area 320, the fourteenth area 321, and the fifteenth area 322 and add corresponding identification 9, 10, 11, 12, 13, 14, and 15, as shown in FIG. 6.

Step 3.6.2: collect image information; the camera collects the image information containing the ice hockey image, and transmits the image information to the smart display device.

Step 3.6.3: analyze and convert the image information; analyze and convert the image information in the smart display device, use the HSV and RGB color range to select orange color pixels, filter out other colors, form a virtual model of the ice hockey, and add it to the virtual scene, and display it; as the hockey puck runs, the virtual model of the hockey puck also runs in the virtual scene.

Step 3.6.4: form a movement trajectory; as the virtual model of the ice hockey puck runs, record the identification of the area passed by the virtual model of the ice hockey in order to form a movement trajectory.

Step 3.6.5: compare; compare the trajectory track with the sequence of region identification in the judgment rule.

Step 3.6.6: make a judgment and score; when there is a trajectory in the running trajectory that is consistent with the sequence of region identification in the judgment rule, the total score of the previous training will be increased by 1, and it will be updated to the total score of this training. At the same time, the running trajectory starts to re-record and proceeds to step 3.6.5 until the training is completed.

Step 4: choose to switch mode or close the application software; the mode name and the total score of this training are combined to form a local history record which is stored in the local database.

In this embodiment, a ball paddle can also be selected as a training venue, and the height of the camera or the focal length of the camera is adjusted so that the ball paddle irradiated by the camera corresponds to the virtual scene.

The above are only the preferred embodiments of the present invention. It should be noted that for those of ordinary skill in the art, without departing from the inventive concept of the present invention, several similar modifications and improvements can be made, which should also be regarded as within the protection scope of the present invention.

What is claimed is:

1. A system with motion capture function applied to ice hockey pass-and-control training, wherein it comprises a running part (203), a detection part (202) and a display part (201); the detection part (202) and the display part (201) are in communication connection;
the running part (203) is a ball device with identifying characteristics, and the running part (203) is provided in correspondence with the detection part (202);
the detection part (202) for detecting the running part and capturing the movement of the running part, forms a detection signal and transmits it to the display part (201);
the display unit (201) is configured to store a virtual scene, receive the detection signal, and display a part of the detection signal in the virtual scene.

2. The system according to claim 1, wherein the display part (201) is in communication connection with the server (1).

3. The system according to claim 1, wherein the detection signal contains the image signal of the running part image, and the display part (201) is configured to add a virtual model corresponding to the image of the running part to the virtual scene.

4. The system according to claim 1, wherein the display part (201) stores judgment rules and mode names, and the mode name is set corresponding to the judgment rule, and is judged according to the judgment rule.

5. The system according to claim 4, wherein the judgment rules include fixed-point judgment rules, and the fixed-point judgment rules include virtual ice hockey setting rules, virtual ice hockey identification, virtual hockey identification order and a score.

6. The system according to claim 5, wherein the method of fixed-point judgment comprises the steps of:
set the virtual ice hockey in the virtual scene according to the virtual ice hockey setting rules in the fixed-point judgment rules, and add the corresponding virtual ice hockey identification;
perform edge detection and obtain the binary image of the running part;
find the virtual ice hockey position and judge whether there is an image of the running part is displayed in the virtual ice hockey;
obtain the order in which the virtual ice hockey appears in the running part, and form the current virtual ice hockey identification order according to the virtual ice hockey identification;
compare the current virtual ice hockey identification order with the virtual ice hockey identification order in the judgment rule.

7. The system according to claim 4, wherein the judgment rules include trajectory judgment rules, and the fixed-point judgment rules include area division rules, area identification, area identification, area identification order and a score.

8. The system according to claim 7, wherein the method of trajectory judgment comprises the steps of:
divide the virtual scene into a plurality of areas according to the area division rules and area identification of the trajectory judgment rules, and add area identification;
obtain the order in which the images of the running part appear in the corresponding area, and form the current area identification order according to the area identification;
compare the current area identification order with the area identification order in the judgment rule.

9. The system with motion capture function applied to ice hockey pass control training according to claim 1 is applied to ice hockey training to form an ice hockey training system, which is characterized in that it includes an ice hockey, an ice hockey stick, an image acquisition device and a display device, and the image acquisition device is in communication connection with the display device;
the ice hockey puck is provided with an identification feature as a running part (203);
the image acquisition device is used as the detection part (202), and the irradiation area of the image acquisition device corresponds to the virtual scene, and is used to detect the ice hockey puck, capture the action of the hockey puck, and form an image signal containing the image of the ice hockey;
the display device is used as a display unit (201) and is used to store judgment rules and virtual scenes, receive image signals, obtain position information of the ice hockey image in the irradiation area, and add the ice hockey image to the virtual scene according to the position information and display ice hockey image, and at the same time, judge according to the position of the ice hockey image in the virtual scene and the judgment rules.

10. The ice hockey training system according to claim 9, wherein the identification feature comprises one or more of color, shape and pattern.

11. The system with motion capture function applied to ice hockey pass control training according to claim 2 is applied to ice hockey training to form an ice hockey training system, which is characterized in that it includes an ice hockey, an ice hockey stick, an image acquisition device and a display device, and the image acquisition device is in communication connection with the display device;
the ice hockey puck is provided with an identification feature as a running part (203);
the image acquisition device is used as the detection part (202), and the irradiation area of the image acquisition device corresponds to the virtual scene, and is used to detect the ice hockey puck, capture the action of the hockey puck, and form an image signal containing the image of the ice hockey;
the display device is used as a display unit (201) and is used to store judgment rules and virtual scenes, receive image signals, obtain position information of the ice hockey image in the irradiation area, and add the ice hockey image to the virtual scene according to the position information and display ice hockey image, and at the same time, judge according to the position of the ice hockey image in the virtual scene and the judgment rules.

12. The ice hockey training system according to claim 11, wherein the identification feature comprises one or more of color, shape and pattern.

13. The system with motion capture function applied to ice hockey pass control training according to claim 3 is applied to ice hockey training to form an ice hockey training system, which is characterized in that it includes an ice hockey, an ice hockey stick, an image acquisition device and a display device, and the image acquisition device is in communication connection with the display device;
the ice hockey puck is provided with an identification feature as a running part (203);
the image acquisition device is used as the detection part (202), and the irradiation area of the image acquisition device corresponds to the virtual scene, and is used to detect the ice hockey puck, capture the action of the hockey puck, and form an image signal containing the image of the ice hockey;
the display device is used as a display unit (201) and is used to store judgment rules and virtual scenes, receive image signals, obtain position information of the ice hockey image in the irradiation area, and add the ice hockey image to the virtual scene according to the position information and display ice hockey image, and at the same time, judge according to the position of the ice hockey image in the virtual scene and the judgment rules.

14. The ice hockey training system according to claim 13, wherein the identification feature comprises one or more of color, shape and pattern.

15. The system with motion capture function applied to ice hockey pass control training according to claim 4 is applied to ice hockey training to form an ice hockey training system, which is characterized in that it includes an ice hockey, an ice hockey stick, an image acquisition device and a display device, and the image acquisition device is in communication connection with the display device;
the ice hockey puck is provided with an identification feature as a running part (203);
the image acquisition device is used as the detection part (202), and the irradiation area of the image acquisition device corresponds to the virtual scene, and is used to detect the ice hockey puck, capture the action of the hockey puck, and form an image signal containing the image of the ice hockey;
the display device is used as a display unit (201) and is used to store judgment rules and virtual scenes, receive image signals, obtain position information of the ice hockey image in the irradiation area, and add the ice hockey image to the virtual scene according to the position information and display ice hockey image, and at the same time, judge according to the position of the ice hockey image in the virtual scene and the judgment rules.

16. The ice hockey training system according to claim 15, wherein the identification feature comprises one or more of color, shape and pattern.

17. The system with motion capture function applied to ice hockey pass control training according to claim 5 is applied to ice hockey training to form an ice hockey training system, which is characterized in that it includes an ice hockey, an ice hockey stick, an image acquisition device and a display device, and the image acquisition device is in communication connection with the display device;
the ice hockey puck is provided with an identification feature as a running part (203);
the image acquisition device is used as the detection part (202), and the irradiation area of the image acquisition device corresponds to the virtual scene, and is used to detect the ice hockey puck, capture the action of the hockey puck, and form an image signal containing the image of the ice hockey;
the display device is used as a display unit (201) and is used to store judgment rules and virtual scenes, receive image signals, obtain position information of the ice hockey image in the irradiation area, and add the ice hockey image to the virtual scene according to the position information and display ice hockey image, and at the same time judge according to the position of the ice hockey image in the virtual scene and the judgment rules.

18. The ice hockey training system according to claim 17, wherein the identification feature comprises one or more of color, shape and pattern.

19. The system with motion capture function applied to ice hockey pass control training according to claim 6 is applied to ice hockey training to form an ice hockey training system, which is characterized in that it includes an ice hockey, an ice hockey stick, an image acquisition device and a display device, and the image acquisition device is in communication connection with the display device;
the ice hockey puck is provided with an identification feature as a running part (203);
the image acquisition device is used as the detection part (202), and the irradiation area of the image acquisition device corresponds to the virtual scene, and is used to detect the ice hockey puck, capture the action of the hockey puck, and form an image signal containing the image of the ice hockey;
the display device is used as a display unit (201) and is used to store judgment rules and virtual scenes, receive image signals, obtain position information of the ice hockey image in the irradiation area, and add the ice hockey image to the virtual scene according to the position information and display ice hockey image, and at the same time, judge according to the position of the ice hockey image in the virtual scene and the judgment rules.

20. The ice hockey training system according to claim 19, wherein the identification feature comprises one or more of color, shape and pattern.
